(19) United States
(12) Patent Application Publication
(10) Pub. No.: US 2008/0296288 A1
(43) Pub. Date: Dec. 4, 2008

(54) Filter for Diesel Fuel with Heater

(75) Inventor: Giorgio Girondi, Mantova (IT)

Correspondence Address: BROWDY AND NEIMARK, P.L.L.C.;624 NINTH STREET, NW, SUITE 300, WASHINGTON, DC, 20001-5303, US

(73) Assignee: UFI FILTERS S.P.A., PORTO MANTOVANO (IT)

(21) Appl. No.: 12/096,012

(22) PCT Filed: Oct. 13, 2006
(86) PCT No.: PCT/EP2006/009953

§ 371 Date: Jun. 3, 2008

(30) Foreign Application Priority Data
Dec. 13, 2005 (IT) RE2005A000139

(51) Int. Cl. B01D 35/18

(52) U.S. Cl. 219/552; 210/185

(57) ABSTRACT

A filter (1) for diesel fuel comprising a tank (11), a filtering cartridge (2) which subdivides the inner volume of the tank (11) into two distinct chambers (50, 60), to which an input conduit (14) of the fuel to be filtered and an output conduit (15) of the filtered fuel are respectively connected, a heater (3), fed by means of electric current and adapted to melt the possible solid paraffins present in the fuel before they reach the filtering separator (21) of the cartridge (2), where said heater (3) has a porous surface (33, 34, 35) adapted to be crossed by the liquid component of the diesel fuel coming from the input conduit (14) and to hold the solid phase component, which forms at temperatures below the paraffination temperature, said porous surface (33, 34, 35) being adapted to be heated in order to liquefy said held solid component, so that it may cross said porous surface (33, 34, 35) in liquid form and reach the chamber (50) of the fuel to be filtered.

### TECHNICAL FIELD

The present invention refers to a filter for diesel fuel in accordance with the preamble of claim 1.

More in particular, the present invention refers to a filter for diesel fuel adapted to melt possibly formed paraffins before they reach the filtering separator.

### BACKGROUND ART

As is known, the solidification of the paraffin substances in diesel fuel often causes problems at the starting of the automobiles fed with said fuel, since the solid paraffins thus formed deposit on the surface of the filtering separator, blocking the diesel fuel from passing through it.

This occurs when the diesel fuel reaches a temperature below that at which paraffins begin to form.

Hence, it is now common practice to install an electrical resistance heater, which begins to function when the fuel temperature is below the paraffination value, warming the diesel fuel in order to melt the solid paraffins, thereby permitting the subsequent filtering without obstruction.

The PTC thermal-resistive elements are among the mostly widely used heaters.

Even if such PTC heaters are capable of carrying out their paraffin-melting function in a useful manner, their use has several drawbacks and disadvantages.

Indeed, they require a rather elaborate configuration for their correct operation, as is known in the field, as well as high energy absorption (several hundred Watts).

Furthermore, the heat necessary for the melting of the paraffins is provided to the fuel part which is in direct contact with the PTC elements; such heated fuel permits the surrounding solid portion to change phase, i.e. to melt. This leads to a relatively high energy expense due to the heating of the liquid phase of the diesel.

### DISCLOSURE OF INVENTION

There is therefore a real need to have available a filter for diesel fuel with heater which is capable of melting the possible solid paraffins present in the fuel itself, before they reach the filtering separator, with a lower energy expense than that required by the PTC resistors of the prior art, so as to correctly operate also with the voltages normally used in the automotive field (12 Volts) and with the normal available power (100-200 Watts), and in any case with voltage and power values less than those necessary for the correct operation of the PTC resistors, in the scope of a simple, compact, and relatively economical construction which may be applied to known filters, without requiring excessive modifications.

Object of the present invention is that of providing a filter having structural and functional characteristics such to satisfy the aforesaid needs and to overcome at the same time the drawbacks mentioned with reference to the prior art.

Such object is attained by means of a filter in accordance with claim 1.

The dependent claims delineate preferred and particularly advantageous embodiments of the filter according to the invention.

### BRIEF DESCRIPTION OF DRAWINGS

Further characteristics and advantages of the invention will be evident from the reading of the following description, provided as exemplifying and not limiting, with the aid of the figures illustrated in the attached tables, wherein:

FIGS. 1 and 4 show an axial section view of a filter, in accordance with the present invention, according to a first and second embodiment, respectively;

FIG. 2 shows a heater used in the filter of FIG. 1, lacking insulating;

FIGS. 2A and 2B show an axial section view of the heater of FIG. 2, without and with insulating, respectively;

FIG. 3 shows a plan view of the heater length;

FIG. 5 shows a section view of the heater with support used in the filter of FIG. 4.

### BEST MODE FOR CARRYING THE INVENTION

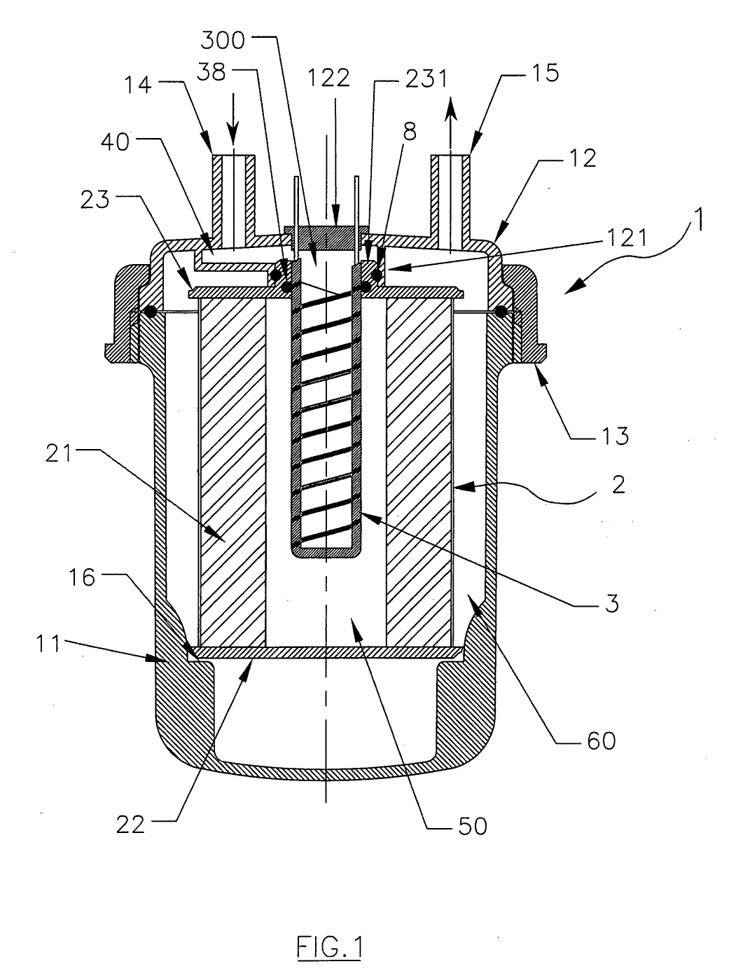

With reference to FIG. 1, where a first embodiment of the present invention is illustrated, a filter for diesel fuel is indicated in its entirety with 1.

In brief, the filter 1 comprises a tank 11, an upper cover 12 seal-coupled on the tank 11 itself by means of a ring nut 13 or seam, an input conduit 14 of the fuel to be filtered, and an output conduit 15 of the filtered fuel.

At its interior, the tank 11 houses a filtering cartridge 2 which, associated with the cover 12, is adapted to subdivide the inner volume into two distinct chambers 50 and 60, of which the first 50 is in fluid communication with the input conduit 14 of the fuel to be filtered and the second 60 with the output conduit 15 of the filtered fuel.

The filtering cartridge 2 comprises a filtering separator 21 of tubular form, of known type, sustained between a lower plate 22 and an upper plate 23 to which it is firmly joined by means of normal fixing means such as glue or welding.

Essentially, the chamber 50 of the fuel to be filtered is that inside the tubular filtering separator 21, while the chamber 60 of the filtered fuel is that which externally surrounds the tubular filtering separator 21.

The lower plate 22 is closed and placed in abutment against an annular abutment 16 made inside the tank 11, while the upper plate 23 is provided with a central hole for the seal-coupling with an electrically conductive, sintered heater 3, placed in communication with the input conduit 14 and the chamber 50, and adapted to prevent the filtering separator 21 from being obstructed with the presence of solid paraffins in the fuel to be filtered, as shall be more clearly seen below.

The filtering cartridge 2 in its entirety is united to the cover 12 of the filter 1 by means of the upper plate 23, which comprises, at the central hole, a projecting shank 231 which is perfectly engaged, with the interposition of a common sealing body 8 (O-ring), inside a corresponding cylindrical seat of the cover 12; the seat is defined by a circular ribbing 121 which projects from the inwardly-turned surface of the same.

In particular, the ribbing 121 surrounds the input conduit 14 and defines an input chamber 40.

In accordance with the present invention, the sintered heater 3 comprises a surface made with porous conductive material and has an overall configuration such to define a chamber 300 within which the fuel arriving from the input conduit 14 is forced to pass before reaching the chamber 50 inside the filtering separator 21.

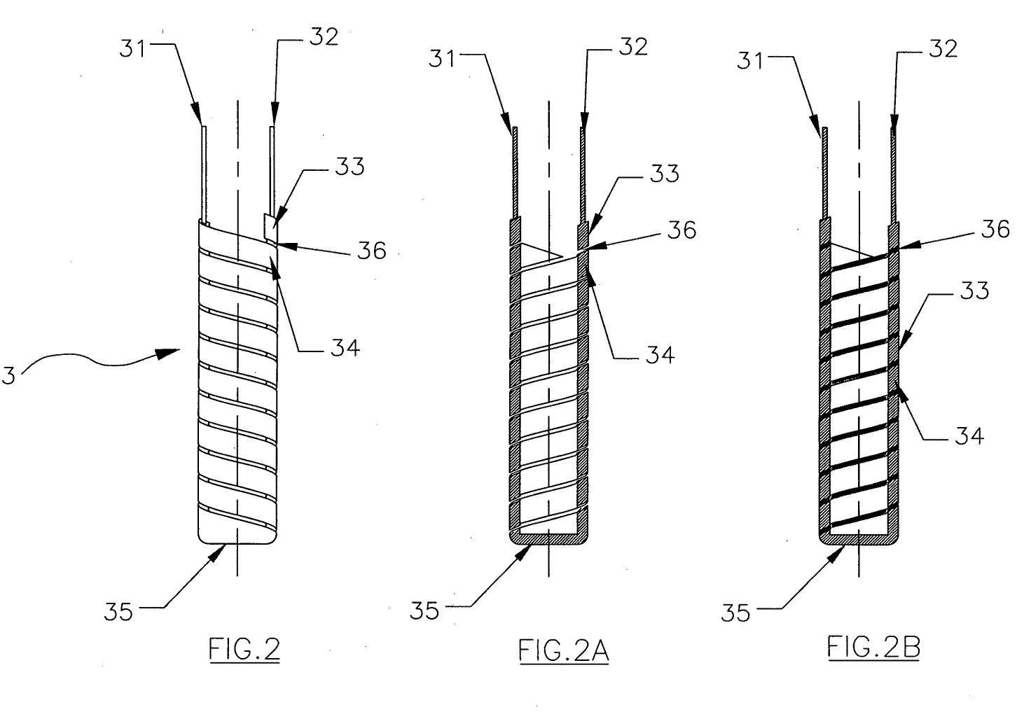

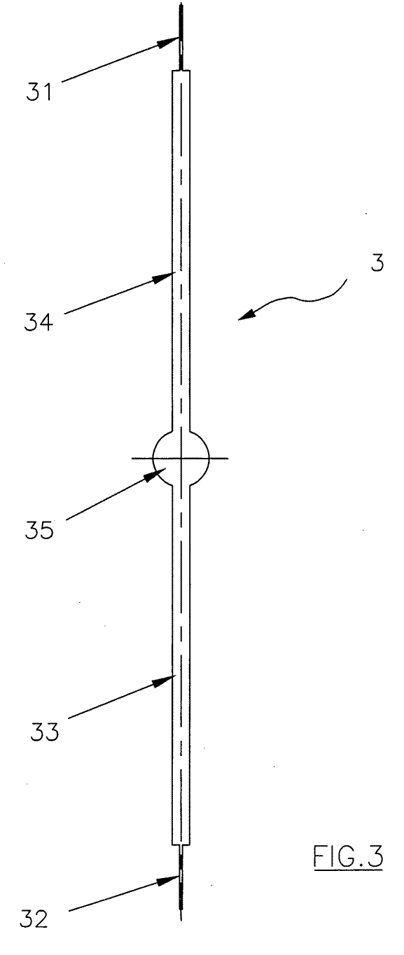

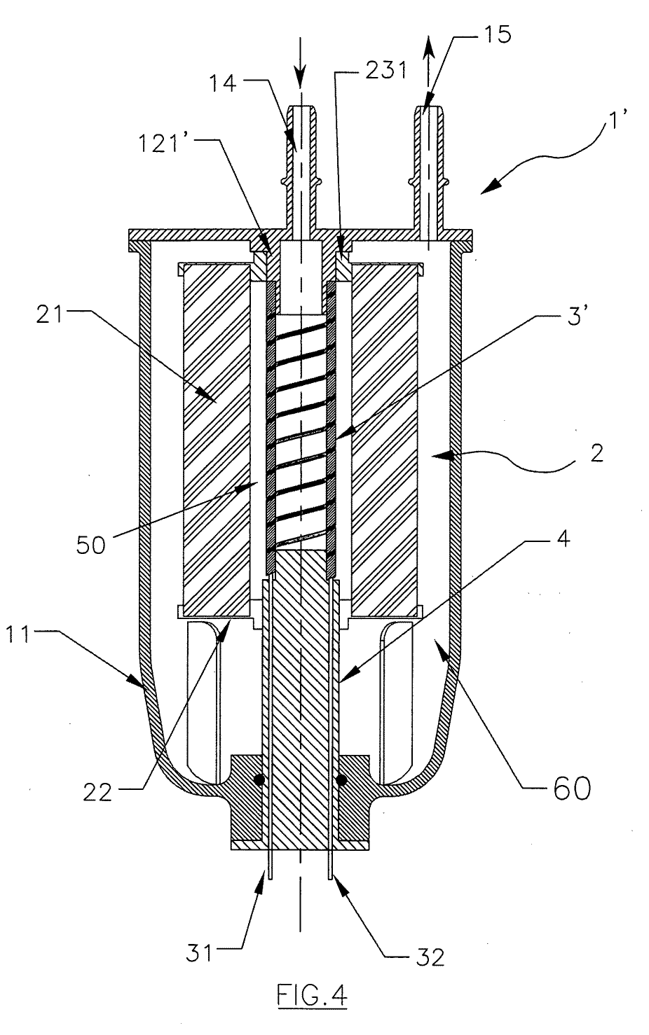

In accordance with the first embodiment, the sintered heater 3 has a cylindrical, glass-shaped configuration, whose open end is perfectly engaged, with the interposition of an O-ring 38, with the inside of the shank 231 projecting from the upper plate 23, so to have the inner chamber 300 directly communicating with the input chamber 40 and therefore with the input conduit 14. More in detail (FIG. 2), the heater 3 is made with conductive sintered material, for example metal, formed by a central circular portion 35 and by two strips 33, 34 which depart from opposite edges from the circular portion 35 itself (FIG. 3); at the free ends of each strip 33 and 34 a conductive element 31, 32, also called pole, is electrically connected for the electrical connection. The two strips 33 and 34 are helically-wrapped (FIG. 2) to form the cylindrical heater 3 with the circular portion 35 situated at the base of the resulting glass. In particular, the two strips 33, 34 are wrapped without touching each other (FIGS. 2,2A), so to leave a space free, between the strip 33 and the strip 34, filled with insulating material 36 (FIG. 2B). The poles 31, 32, which depart from the open end of the glass-shaped cylinder, are made to come out from the filter 1 through an opening made on the cover 12; the opening acts as a seat for a cap 122 of electrically insulating material crossed by the poles 31, 32 themselves.

By virtue of the helical wrapping of the strips 33, 34 of the heater 3, it is possible to obtain a cylinder of compact dimensions while maintaining the poles 31, 32 at a considerable distance, due to total length of the strip 33 and strip 34; in this manner, the resistance of the sintered heater 3 is high, and consequently the heat which may be transmitted may achieve suitable values for the paraffin melting, even with low voltages (e.g. 12 Volts).

The sintered material used for making the heater 3 has a greater porosity with respect to that of the filtering separator 21, but is sufficient to hold possible paraffins. In such a manner, the normal contaminant particles present in the fuel are not held by the heater 3 but exclusively by the filtering separator 21. Therefore, the porous heater 3 allows the liquid part of the fuel to pass through the pores, while it holds the solid part of the same so to immediately liquefy it with the electrically-provided heat; the solid part immediately passes through the pores after its change of phase.

Preferably, the porous heater 3 has pores with size comprised between 10 and 100 μm.

By virtue of such configuration, the energy necessary for heating the heater is exclusively employed for melting the paraffins held and therefore for realising the solid phase to liquid phase passage of the paraffins present in the diesel fuel.

Among the metallic materials which may be employed for making the heater 3 according to the invention, it is possible to use: stainless steel, Fe—Ni—Cr alloys, Barium Titanate and/or other metallic or ceramic materials currently used for electric or PTC heaters.

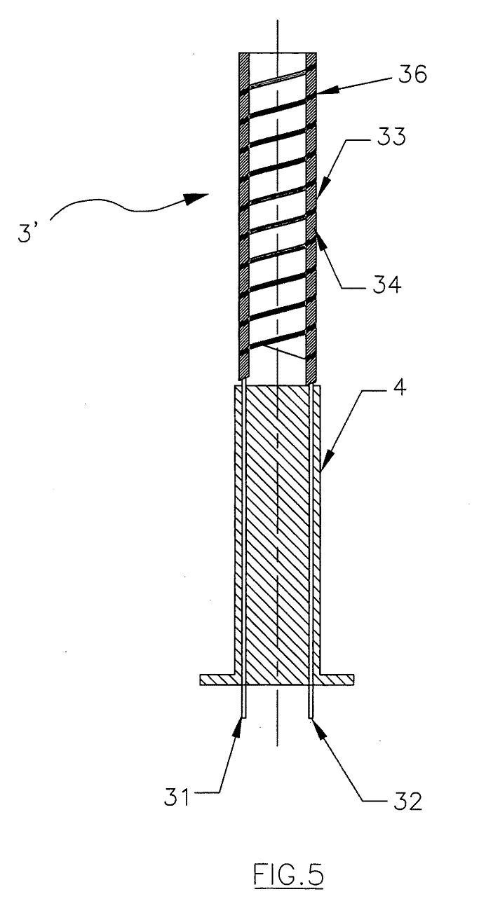

In FIGS. 4 and 5, a second embodiment of the filter 1 is illustrated, wherein for the sake of simplicity the elements in common with the preceding embodiment are indicated with the same numeric references and are not newly described.

In particular, this second embodiment illustrates a filter 1′ comprising a heater, indicated with 3′, entirely analogous to that described above, which is however open on both opposite ends, i.e. is shaped as a cylinder.

The sintered heater 3′ is attached to a removable support 4 which may be associated to the filter 1 by means of rapid fixing means. Therefore, unlike the first embodiment wherein the heater 3 is definitively fixed to the upper plate 23 of the cartridge 2 through the O-ring 38, in this second embodiment it may be independently substituted from the cartridge 2 itself.

In the example of FIG. 4, the heater 3′, situated inside the chamber 50, has a cylindrical shape open at the two opposite ends; one end is fixed to the support 4 and the other end is removably engaged to an annular shank 121′ centrally projecting from the cover 12, made in correspondence with the input conduit 14 and to which the shank 231 of the upper plate 23 of the cartridge 2 is likewise engaged.

In particular, the support 4 has a solid cylindrical body made in insulating material, adapted to be inserted within an opening made on the tank 11, from the side opposite that of the input conduit 13, and to pass through a corresponding opening, sealing it, made centrally on the lower plate 22′, so to place the heater 3′ within the chamber 50. For the usual electrical connections, the poles 33, 34 of the heater 3′ come out from the filter 1′, crossing inside the support 4 itself. Operatively, and for the sake of description brevity with reference only to the first embodiment illustrated in FIG. 1: the diesel fuel enters into the filter 1 through the input conduit 14, first crosses the input chamber 40, then subsequently enters into the inner chamber 300 of the sintered heater 3, through the porous material surface formed by the strips 33, 34 and by the central element 35 (without being filtered, since the porosity is not sufficient for holding the contaminant particles), enters into the chamber 50 through the filtering separator 21, reaches the chamber 60 and exits the filter 1 through the output conduit 15.

When the diesel fuel reaches temperatures below that of paraffination of the diesel fuel to be filtered, the heater 3 is electrically fed through the two poles 33, 34, heating up until it melts the paraffin particles formed in the fuel and held by the heater itself. The paraffins, upon melting, are no longer held by the porous surface of the heater 3 and pass through it, reaching the chamber 50 together with the liquid part of the fuel.

In the preceding examples, explicit reference was made to a cylindrical conformation of the heater 3; nevertheless, any other shape suitable for ensuring the passage of the fuel through the porous conductive material before reaching the filtering separator may be used.

As may be appreciated from that described, the filter, according to the present invention, permits satisfying the needs and overcoming the drawbacks mentioned in the introductive part of the present description with reference to the prior art.

Indeed, the filter for diesel fuel according to the present invention permits effectively filtering the diesel fuel wherein possible solid paraffins are present due to the sintered heater, which requires a lower quantity of energy than that usually required of the known PTC heaters, since it directly heats only the paraffins which deposit on its surface, allowing the liquid part to pass directly through it, which therefore does not remain in contact with the heated surface.

Moreover, the cylindrical surface obtained with the helical wrapping of the strips forming the porous surface permits obtaining an extremely compact and highly efficient heater, making possible the achievement of suitable temperatures with the voltages used in the automotive field (12 Volts) and with the power available (100-200 Watts) with the usual batteries.

Of course, with the object of satisfying contingent and specific needs, a man skilled in the art may bring numerous modifications and variants to the filter described above, all moreover contained within the protective scope of the invention, as defined by the following claims.

1. Filter (1,1′) for diesel fuel comprising a tank (11), a filtering cartridge (2) which subdivides the inner volume of the tank (11) into two distinct chambers (50, 60), to which an input conduit (14) of the fuel to be filtered and an output conduit (15) of the filtered fuel are respectively connected, a heater (3,3′), fed by means of electric current and adapted to melt the possible solid paraffins present in the fuel before they reach the filtering separator (21) of the cartridge (2), characterised in that said heater (3,3′) has a surface (33, 34, 35) made with porous conductive material that is crossed by the liquid component of the diesel fuel coming from the input conduit (14) and holds the solid phase component, which forms at temperatures lower than the paraffination temperature, said surface (33, 34, 35) being electrically heated in order to liquefy said held solid component, so that it may cross said surface (33, 34, 35) in liquid form and reach the chamber (50) of the fuel to be filtered.

2. Filter (1,1′) according to claim 1, wherein said porous surface (33,34,35) is made with electrically conductive sintered material.

3. Filter (1,1′) according to claim 2, wherein said porous surface (33,34,35) is in metallic or ceramic material.

4. Filter (1,1′) according to claim 3, wherein said material is chosen from among stainless steel, Fe—Ni—Cr alloys, Barium Titanate and/or other metallic or ceramic materials currently used for electrical or PTC heaters.

5. Filter (1,1′) according to claim 1, wherein said heater (3,3′) has a cylindrical conformation formed by a pair of helically-wrapped porous strips (33,34) with the interposition of an insulating material (36), said strips (33,34) forming said porous surface.

6. Filter (1,1′) according to claim 5, wherein an end of each strip (33,34) has a pole (31,32) for the electrical connection.

7. Filter (1) according to claim 5, wherein said heater (3) has a cylindrical, glass-shaped conformation defining a chamber (300) at its interior placed in communication with said input conduit (13).

8. Filter (1, 1′) according to claim 5, wherein said heater (3, 3′) is situated inside said chamber (50) of the fuel to be filtered.

9. Filter (1′) according to claim 1, wherein said heater (3′) is fixed to a support 4 which may be removably associated with the filter (1′) itself.

10. Filter (1,1′) according to claim 1, wherein said porous conductive surface has pores of size comprised between 10 and 100 μm.

11. Filter (1,1′) according to claim 1, wherein said porous conductive surface used for making the heater (3) has a greater porosity with respect to that of the filtering separator (21).

12. Electrical heater (3,3′) for diesel fuel, adapted to melt the possible paraffins present in the fuel before they reach the filtering separator (21) of a cartridge (2) placed inside a filter (1,1′), characterised in that it comprises a surface (33, 34, 35) made with porous conductive material that is crossed by the liquid component of the diesel fuel and holds the solid phase component which forms at temperatures below the paraffination temperature, said surface (33, 34, 35) being electrically heated in order to liquefy said held solid component, so that it may cross said surface (33, 34, 35) in liquid form.

13. Heater (3,3′) according to claim 12, wherein said porous conductive surface (33,34,35) is made with electrically conductive sintered material.

14. Heater (3,3′) according to claim 13, having a cylindrical conformation formed by a pair of helically-wrapped porous strips (33,34) with the interposition of an insulating material (36).
